(19) United States
(12) Patent Application Publication
(10) Pub. No.: US 2009/0044145 A1
(43) Pub. Date: Feb. 12, 2009

(54) METHOD FOR OFFERING ADVERTISEMENT IN ASSOCIATION WITH CONTENTS IN VIEW AND SYSTEM FOR EXECUTING THE METHOD

(75) Inventor: Mi Jung Seo, Seoul (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 12/162,650

(22) PCT Filed: Jan. 16, 2007
(86) PCT No.: PCT/KR2007/000252

§ 371 Date: Jul. 30, 2008

(30) Foreign Application Priority Data
Feb. 1, 2006 (KR) 10-2006-0009778

(51) Int. Cl. G06F 3/048

(52) U.S. Cl. 715/804

(57) ABSTRACT

A method of providing advertising associated with a content in a visible area, and a system for executing the method are provided. A method of providing advertising associated with a content includes the steps of: dividing a webpage into a plurality of content areas using a predetermined area division scheme; identifying a content area where a predetermined event occurs, when the event occurs on the webpage; identifying a content included in the identified content area; and providing advertising associated with the identified content.

### TECHNICAL FIELD

The present invention relates to a method of providing advertising associated with a content in a visible area, and a system for executing the method.

### BACKGROUND ART

In the case of a webpage simultaneously displaying a plurality of contents with various themes, when initial advertising is displayed on the webpage, the initial advertising is displayed to a user, although the user may scroll through the webpage and read different content with a different theme.

For example, in the case of a webpage having a comparatively greater length or simultaneously displaying a plurality of contents with various themes, although a change in the user's interest into another content with a different theme may occur, initial advertising is displayed as is, which results in failing to attract the user's attention.

FIG. 1 is a flowchart illustrating a method of matching and providing a content and advertising according to a conventional art. According to the conventional art shown in FIG. 1, a method of analyzing each of the content and advertising, and providing matched advertising is employed. Accordingly, although a user reads another content on the same webpage, initially displayed advertising does not change.

Accordingly, in the case of advertising which is associated with only a single content on a webpage containing a plurality of contents with various themes, it may be incompatible with an intention of an advertiser which desires to satisfy a user's interest even when the user's interest changes into another content.

### DISCLOSURE OF INVENTION

### Technical Goals

The present invention provides a method of identifying a content in a visible area using a predetermined event on a webpage, and providing advertising associated with the content.

It is an aspect of the present invention to identify a content, which a user is interested in, by using a predetermined event occurring on a webpage, such as a mouse-over, a drag, a click, a scrolling event, and the like, and provide advertising associated with the identified content. In this instance, the webpage is divided into a plurality of content areas.

It is another aspect of the present invention to continuously provide advertising associated with a content, which a user is interested in, by using advertising formed in a skyscraper type and advertising formed in a fixed type, irrespective of whether a scrolling event occurs.

It is still another aspect of the present invention to provide advertising associated with a content that a user is currently viewing, and thereby fit an advertiser's intention to provide advertising associated with the content that the user is interested in.

### Technical Solutions

According to an aspect of the present invention, there is provided a method of providing advertising associated with a content, the method including the steps of: dividing a webpage into a plurality of content areas using a predetermined area division scheme; identifying a content area where a predetermined event occurs, when the event occurs on the webpage; identifying a content included in the identified content area; and providing advertising associated with the identified content.

In this instance, the step of identifying the content area may include the step of: identifying an area where a user enter event occurs as the content area, when the event corresponds to the user enter event.

Also, the step of identifying the content area may further include the step of: identifying a valid area after a scrolling event occurs as the content area, when the event corresponds to the scrolling event.

Also, the step of providing may include the steps of: selecting any one of a skyscraper type advertising and a fixed type advertising depending upon a scrolling event; and providing the advertising in the selected type.

According to another aspect of the present invention, there is provided a system for displaying advertising associated with a content, the system including: a content area divider dividing a webpage into a plurality of content areas using a predetermined area division scheme; a content area identifier identifying a content area where a predetermined event occurs, when the event occurs on the webpage; a content identifier identifying a content included in the identified content area; and an advertising provider providing advertising associated with the identified content.

According to still another aspect of the present invention, there is provided a method of providing advertising associated with a content, the method including the steps of: dividing a webpage into a plurality of content areas using a predetermined area division scheme; identifying a visible area of the webpage, the visible area being provided from a user terminal; identifying a content area associated with the identified visible area; and providing advertising associated with a content included in the identified content area.

In this instance, the step of identifying the visible area may include the step of: identifying an area where at least one of 1) a mouse-over a word on the webpage or the content area, 2) a drag of a word or a sentence via a mouse, and 3) a mouse click on the webpage occurs, as the visible area.

Also, the step of identifying the visible area may include the step of: identifying a content area, occupying a largest proportion of content area among the plurality of content areas, as the visible area, the plurality of content areas being outputted according to a scrolling event after the scrolling event occurs.

Also, the step of providing may include the steps of: selecting any one of a skyscraper type advertising and a fixed type advertising depending upon a scrolling event; and providing the advertising in the selected type.

Also, the area division scheme may include a scheme of dividing the webpage into the plurality of content areas using a program code. In this instance, the program code is divided into content units to constitute the webpage. Also, the area division scheme may include a scheme of dividing the webpage into the plurality of content areas using a blog bulletin board.

### BRIEF DESCRIPTION OF DRAWINGS

FIG. 1 is a flowchart illustrating a method of matching and providing a content and advertising according to a conventional art;

FIG. 2 is a flowchart illustrating a method of providing advertising associated with a content in a visible area using an event according to an exemplary embodiment of the present invention;

FIG. 3 illustrates an example of dividing a webpage into a plurality of content areas according to an exemplary embodiment of the present invention;

FIG. 4 illustrates an example of a method of identifying a content area depending upon a user enter event and a method of providing advertising associated with a content according to an exemplary embodiment of the present invention;

FIG. 5 illustrates an example of a method of identifying a content area depending upon a scrolling event and a method of providing advertising associated with a content according to an exemplary embodiment of the present invention;

FIG. 6 illustrates an example of skyscraper type advertising associated with a scrolling event on a webpage according to an exemplary embodiment of the present invention;

FIG. 7 illustrates an example of fixed type advertising associated with a scrolling event on a webpage according to an exemplary embodiment of the present invention;

FIG. 8 is a block diagram illustrating an internal configuration of a system for providing advertising associated with a content in a visible area according to an exemplary embodiment of the present invention;

FIG. 9 is a block diagram illustrating an internal configuration of a content area identifier according to an exemplary embodiment of the present invention;

FIG. 10 is a block diagram illustrating an internal configuration of an advertising provider according to an exemplary embodiment of the present invention; and

FIG. 11 is a flowchart illustrating a method of providing advertising associated with a content in a visible area according to an exemplary embodiment of the present invention.

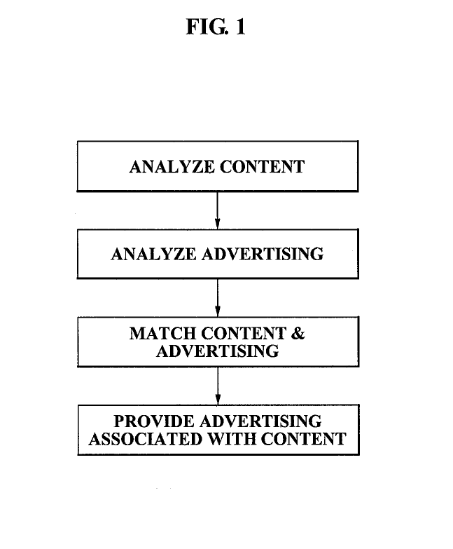

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

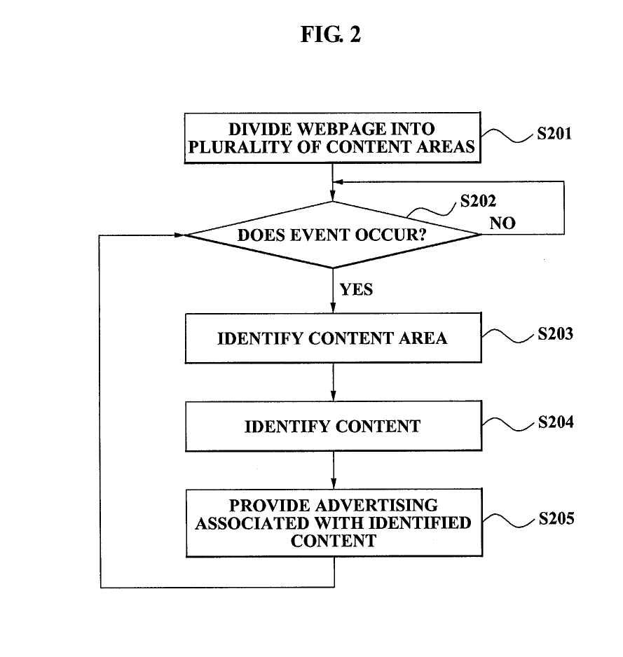

FIG. 2 is a flowchart illustrating a method of providing advertising associated with a content in a visible area using an event according to an exemplary embodiment of the present invention.

In operation S201, a system for providing advertising associated with a content in a visible area divides a webpage into a plurality of content areas using a predetermined area division scheme. In this instance, the area division scheme may include a scheme of dividing the webpage into the plurality of content areas using a program code which is divided into content units to constitute the webpage. Also, the area division scheme may include a scheme of dividing the webpage into the plurality of content areas using a blog bulletin board.

In operation S202, the system identifies whether the event occurs. When the event occurs, the system performs operation S203, otherwise, the system waits for the event to occur. In this instance, the event may include a user enter event or a scrolling event. Also, the user enter event may include at least one of 1) a mouse-over a word on the webpage or the content area, 2) a drag of a word or a sentence via a mouse, and 3) a mouse click on the webpage.

In operation S203, the system identifies a content area where the event occurs, when the event occurs on the webpage. In this instance, when the event corresponds to the user enter event, the system identifies an area where the user enter event occurs, as the content area. Also, when the event corresponds to the scrolling event, the system identifies a valid area as the content area.

In operation S204, the system identifies a content included in the identified content area.

In operation S205, the system provides advertising associated with the identified content. In this instance, the system selects any one of a skyscraper type advertising and a fixed type advertising depending upon a scrolling event, and provides the advertising in the selected type.

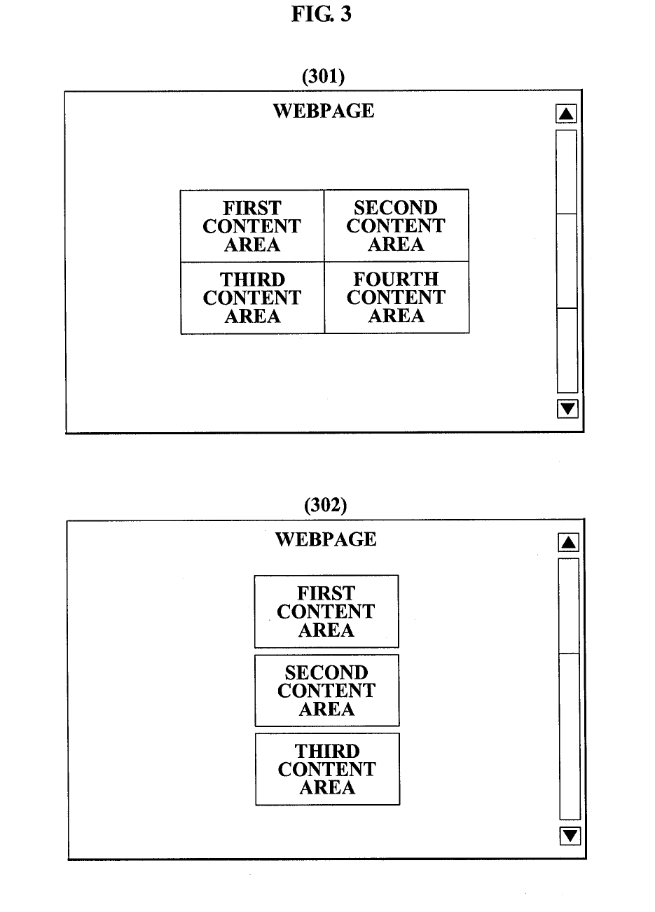

FIG. 3 illustrates an example of dividing a webpage into a plurality of content areas according to an exemplary embodiment of the present invention.

A webpage 301 shows an example of a scheme of dividing the webpage into the plurality of content areas using a program code. In this instance, the program code is divided into content units to constitute the webpage.

Another webpage 302 shows an example of a scheme of dividing the webpage into the plurality of content areas using a blog bulletin board. When a plurality of contents with various themes is aligned on the webpage, like the bog, the webpage may be divided into the plurality of content areas according to a bulletin board enrolled in the blog.

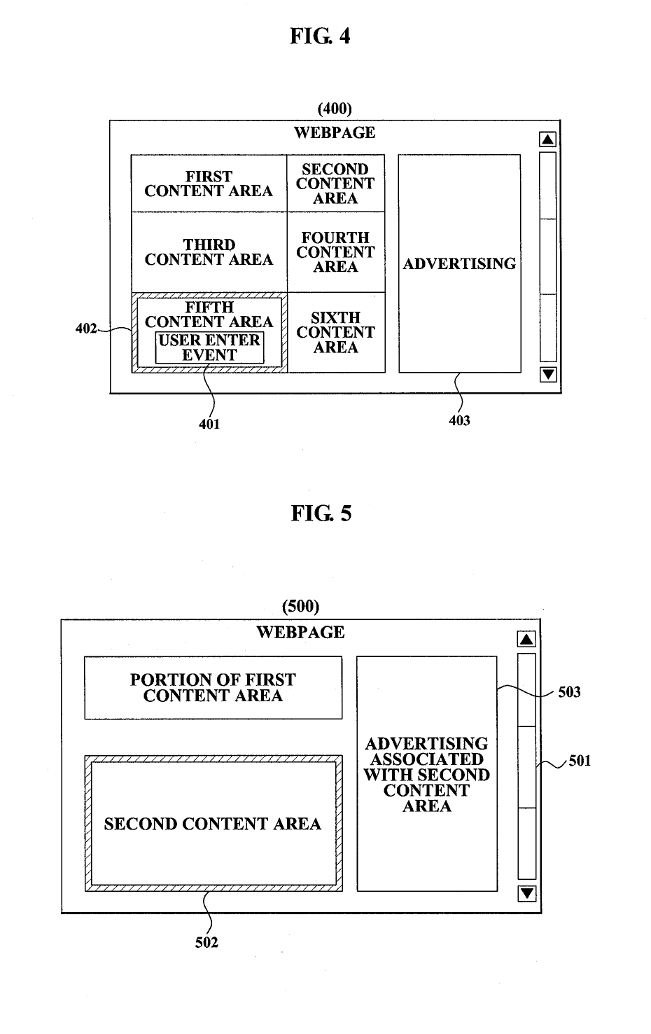

FIG. 4 illustrates an example of a method of identifying a content area depending upon a user enter event and a method of providing advertising associated with a content according to an exemplary embodiment of the present invention.

A webpage 400 is classified into a plurality of content areas and advertising areas. Also, the webpage 400 shows a method of identifying a fifth content area 402 where a user enter event 401 occurs, identifying a content including the fifth content area 402, and providing advertising 403 associated with the identified content.

FIG. 5 illustrates an example of a method of identifying a content area depending upon a scrolling event and a method of providing advertising associated with a content according to an exemplary embodiment of the present invention.

A scroll bar 501 corresponds to an instrument which displays where current screen information is located on a webpage 500 when all information of the webpage 500 is not able to be displayed at one time. Accordingly, a user may change a location of information to be displayed on a screen using the scroll bar 501.

A second content area 502 indicates a content area occupying a largest proportion of content area on a screen after the scrolling event occurs. In this instance, a content included in the second content area 502 is identified, and advertising 503 associated with the identified content is displayed.

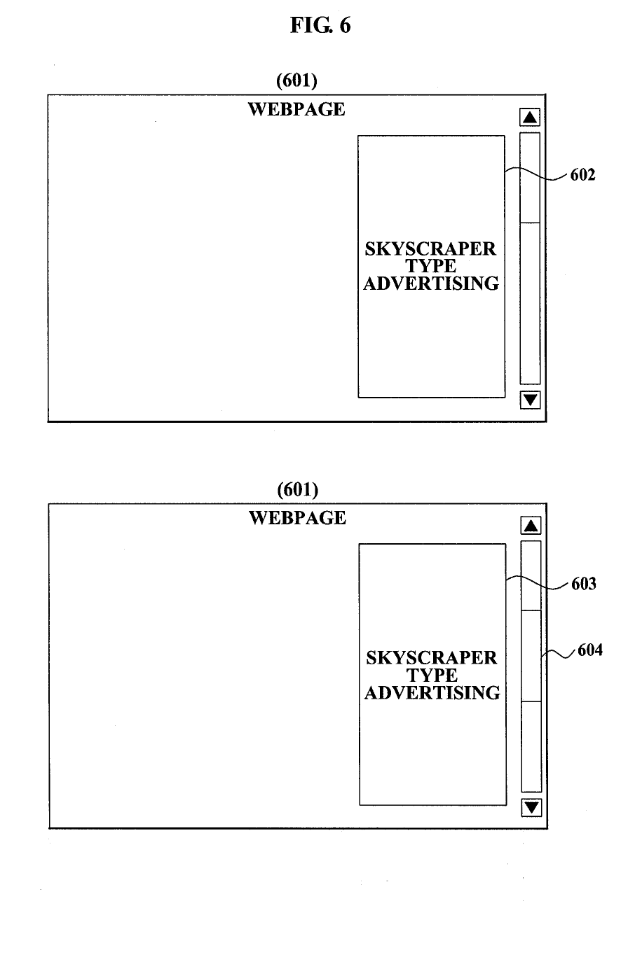

FIG. 6 illustrates an example of skyscraper type advertising associated with a scrolling event on a webpage according to an exemplary embodiment of the present invention.

Skyscraper type advertising 602 and 603 faces each other on a webpage 601, and is located in a right side of the webpage 601 to readily attract the user's attention. Also, the skyscraper type advertising 602 and 603 is formed in a vertically extended rectangular shape.

Accordingly, when the user scrolls down a scroll bar 304 to view another content, the skyscraper type advertising 602 and 603 may be continuously displayed on the webpage 601 to thereby attract the user's attention.

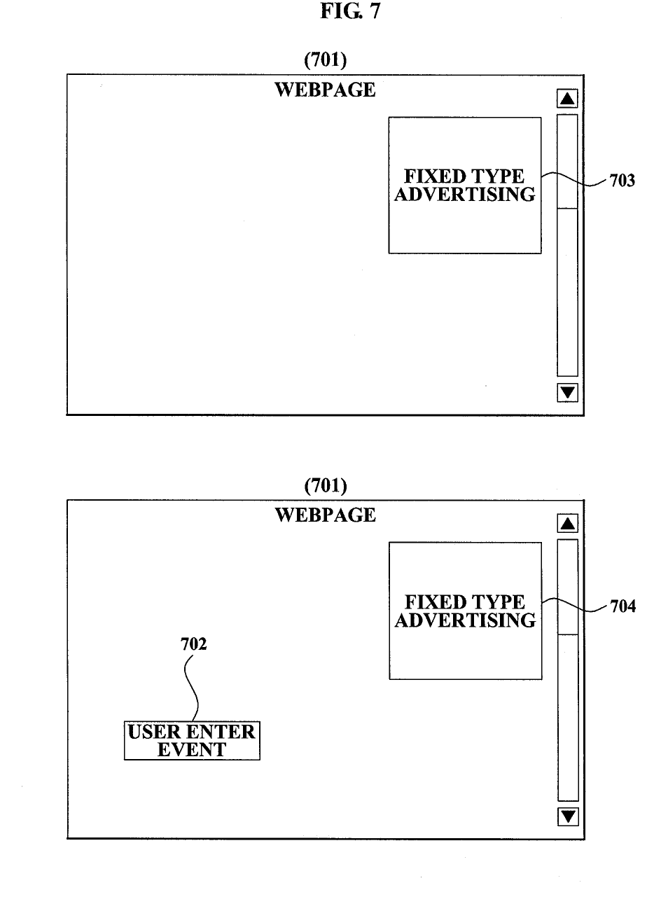

FIG. 7 illustrates an example of fixed type advertising associated with a scrolling event on a webpage according to an exemplary embodiment of the present invention.

A webpage 701 may display advertising associated with a content, which a user is interested in, by identifying a content of a content area where a user enter event 702 occurs, and changing fixed type advertising 703 into another fixed type advertising 704 associated with the content. Also, the fixed type advertising 703 and 704 may include banner advertising.

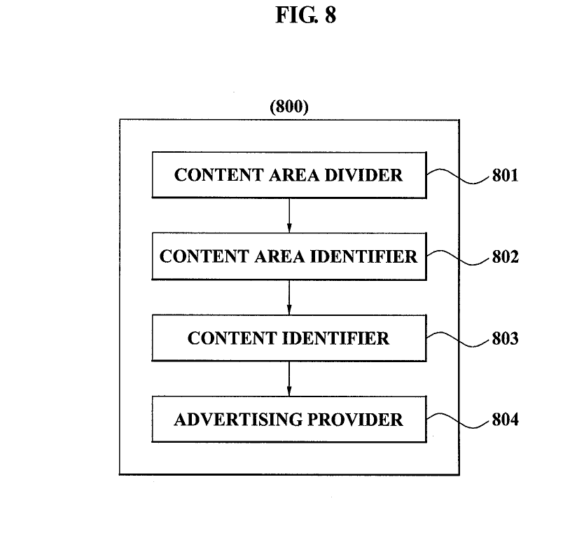

FIG. 8 is a block diagram illustrating an internal configuration of a system for providing advertising associated with a content in a visible area according to an exemplary embodiment of the present invention. In FIG. 8, a system 800 for providing advertising associated with a content is provided. In this instance, the system 800 may include a content area divider 801, a content area identifier 802, a content identifier 803, and an advertising provider 804.

The content area divider 801 divides a webpage into a plurality of content areas using a predetermined area division scheme. In this instance, the area division scheme may include a scheme of dividing the webpage into the plurality of content areas using a program code which is divided into content units to constitute the webpage. Also, the area division scheme may include a scheme of dividing the webpage into the plurality of content areas using a blog bulletin board.

The content area identifier 802 identifies a content area where a predetermined event occurs, when the event occurs on the webpage. In this instance, the event may include a user enter event or a scrolling event.

The content identifier 803 identifies a content included in the identified content area.

The advertising provider 804 provides advertising associated with the identified content. As described above, it is possible to identify the content, which the user is interested in, using the user enter event and/or the scrolling event, and provide advertising appropriate for an intention of an advertiser, which desires to provide advertising associated with the identified content.

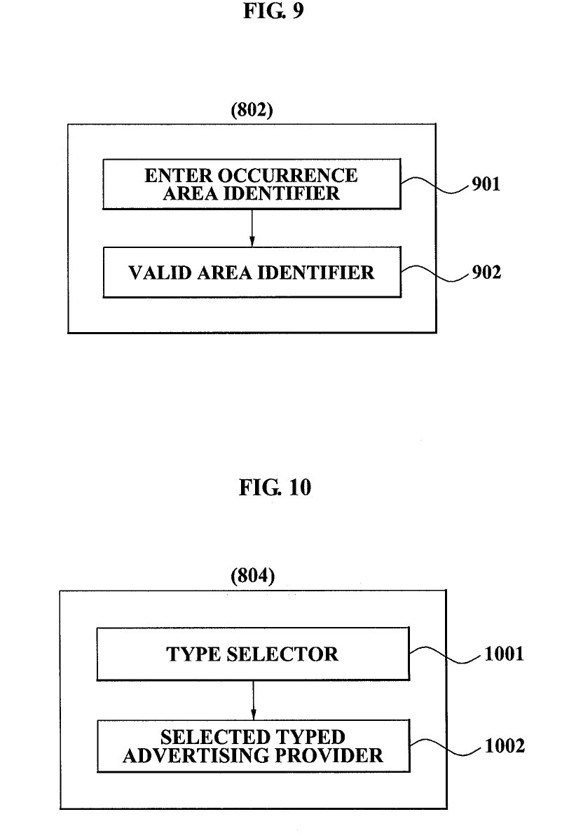

FIG. 9 is a block diagram illustrating an internal configuration of the content area identifier 802 according to an exemplary embodiment of the present invention. As shown in FIG. 9, the content area identifier 802 may include an enter occurrence area identifier 901 and a valid area identifier 902.

The enter occurrence area identifier 901 identifies an area where a user enter event occurs, as the content area, when the event corresponds to the user enter event. In this instance, the user enter event may include at least one of 1) a mouse-over a word on the webpage or the content area, 2) a drag of a word or a sentence via a mouse, and 3) a mouse click on the webpage.

The valid area identifier 902 identifies a valid area where a scrolling event occurs, as the content area, when the event corresponds to the scrolling event. In this instance, the valid area may include a content area occupying a largest proportion of content area among the plurality of content areas which are outputted according to the scrolling event.

Through the enter occurrence area identifier 901 and the valid area identifier 902, it is possible to identify a content area, which a user is interested in, by using the user enter event or the scrolling event, irrespective of the length of the webpage.

FIG. 10 is a block diagram illustrating an internal configuration of the advertising provider 804 according to an exemplary embodiment of the present invention. The advertising provider 804 may include a type selector 1001 and a selected typed advertising provider 1002.

The type selector 1001 selects any one of a skyscraper type advertising and a fixed type advertising depending upon a scrolling event. When the scrolling event is needed, the type selector 1001 selects the skyscraper type which enables advertising to be continuously displayed on a screen even when the scrolling event occurs. Conversely, when the scrolling event is not needed, the typed selector 1001 selects the fixed type.

The selected typed advertising provider 1002 provides skyscraper type advertising and/or fixed type advertising depending upon the selected type.

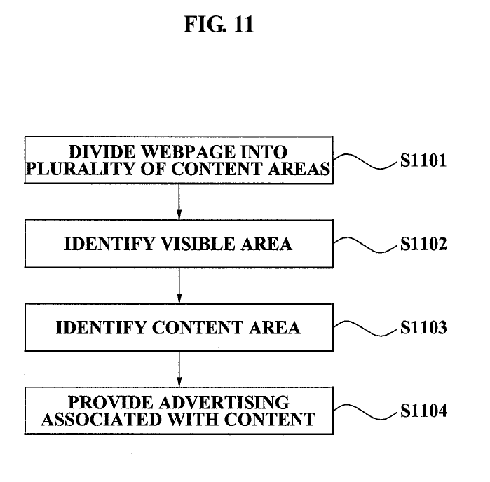

FIG. 11 is a flowchart illustrating a method of providing advertising associated with a content in a visible area according to an exemplary embodiment of the present invention. FIG. 11 illustrates a method of identifying a content in a visible area, and providing advertising associated with the identified content, which is different from a method of identifying a content, which a user is interested in, by using an event.

The method includes: operation S1101 of dividing a webpage into a plurality of content areas using a predetermined area division scheme; operation S1102 of identifying a visible area of the webpage, the visible area being provided from a user terminal; operation S1103 of identifying a content area associated with the identified visible area; and operation S1104 of providing advertising associated with a content included in the identified content area.

In operation S1101, the area division scheme may include a scheme of dividing the webpage into the plurality of content areas using a program code which is divided into content units to constitute the webpage.

Also, the area division scheme may include a scheme of dividing the webpage into the plurality of content areas using a blog bulletin board.

In operation S1102, an area where at least one of 1) a mouse-over a word on the webpage or the content area, 2) a drag of a word or a sentence via a mouse, and 3) a mouse click on the webpage occurs may be identified as the visible area.

Also, in operation S1102, a content area, occupying a largest proportion of content area among the plurality of content areas, may be identified as the visible area. In this instance, the plurality of content areas is outputted according to a scrolling event after the scrolling event occurs.

Operation S1104 may include selecting any one of a skyscraper type advertising and a fixed type advertising depending upon a scrolling event; and providing the advertising in the selected type.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

According to the present invention, it is possible to identify a content, which a user is interested in, by using a predetermined event occurring on a webpage, such as a mouse-over, a drag, a click, a scrolling event, and the like, and provide advertising associated with the identified content. In this instance, the webpage is divided into a plurality of content areas.

Also, according to the present invention, it is possible to continuously provide advertising associated with a content, which a user is interested in, by using advertising formed in a skyscraper type and advertising formed in a fixed type, irrespective of whether a scrolling event occurs.

Also, according to the present invention, it is possible to provide advertising associated with a content that a user is currently viewing, and thereby fit an advertiser's intention to provide advertising associated with the content that the user is interested in.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1-19. (canceled)

20. A method of providing advertising associated with a content, the method comprising the steps of:
dividing a webpage into a plurality of content areas according to a predetermined area division scheme;
detecting a predetermined interaction of a user with a currently displayed webpage, the currently displayed webpage including a plurality of content areas;
identifying a first content area associated with the predetermined interaction of the user;
identifying a content associated with the first content area; and
in response to the detecting of the user's predetermined interaction, providing advertising associated with the identified content.

21. The method of claim 20, wherein the predetermined interaction of the user includes at least one of three events comprising 1) a mouse-over, 2) a mouse drag, and 3) a mouse click on an object associated with the first content area.

22. The method of claim 21, wherein the step of identifying a first content area associated with the predetermined interaction of the user comprises the step of:
determining an area to be the first content area where the user's predetermined interaction occurs.

23. The method of claim 20, wherein the predetermined interaction of the user includes a scrolling through at least a portion of the content areas included in the webpage.

24. The method of claim 23, wherein the step of identifying a first content area associated with the predetermined interaction of the user comprises the step of:
determining the first content area based, at least in part, upon proportion of each content area displayed by the scrolling operation.

25. The method of claim 20, wherein the step of providing comprises the steps of:
selecting either a skyscraper type advertising or a fixed type advertising depending upon a scrolling operation; and
providing the advertising in the selected type.

26. The method of claim 20, wherein the area division scheme includes a scheme of dividing the webpage into the plurality of content areas using a program code, the program code being divided into content units to constitute the webpage.

27. The method of claim 20, wherein the area division scheme includes a scheme of dividing the webpage into the plurality of content areas using a blog bulletin board.

28. A method of providing advertising associated with a content, the method comprising the steps of:
dividing a webpage into a plurality of content areas according to a predetermined area division scheme;
identifying a currently displayed area of a webpage on a user terminal, the webpage including a plurality of content areas;
identifying a first content area associated with the currently displayed area; and
in response to the identifying of the currently displayed area, providing advertising associated with a content included in the first content area.

29. The method of claim 28, wherein the step of identifying a currently displayed area of a webpage on a user terminal comprises the step of: identifying an area where at least one of three events occurs, the three events comprising: 1) a mouse-over, 2) a mouse drag, and 3) a mouse click on an object associated with the currently displayed area.

30. The method of claim 28, wherein the step of identifying a currently displayed area of a webpage on a user terminal comprises the step of: identifying a scrolling through at least a portion of the content areas included in the webpage.

31. The method of claim 28, wherein the step of providing comprises the steps of:
selecting either a skyscraper type advertising or a fixed type advertising depending upon a scrolling operation; and
providing the advertising in the selected type.

32. The method of claim 28, wherein the area division scheme includes a scheme of dividing the webpage into the plurality of content areas using a program code, the program code being divided into content units to constitute the webpage.

33. The method of claim 28, wherein the area division scheme includes a scheme of dividing the webpage into the plurality of content areas using a blog bulletin board.

34. One or more computer-readable media having stored thereon a computer program that, when executed by one or more processors, causes the one or more processors to perform acts including:
dividing a webpage into a plurality of content areas according to a predetermined area division scheme;
detecting a predetermined interaction of a user with a currently displayed webpage, the currently displayed webpage including a plurality of content areas;
identifying a first content area associated with the predetermined interaction of the user;
identifying a content associated with the first content area; and
in response to the detecting of the user's predetermined interaction, providing advertising associated with the identified content.

35. A system for displaying advertising associated with a content, the system comprising:
at least one memory storing instructions;
one or more processors for processing data;
a content area divider configured for dividing a webpage into a plurality of content areas using a predetermined area division scheme;
a content area identifier configured for detecting a predetermined interaction of a user with a currently displayed webpage and for identifying a first content area associated with the predetermined interaction of the user;
a content identifier configured for identifying a content associated with the first content area; and
an advertising provider for providing advertising associated with the identified content.

36. The system of claim 35, wherein the content area identifier comprises:
an enter occurrence area identifier configured for identifying an area where the interaction of the user occurs.

37. The system of claim 35, wherein the content area identifier further comprises:
a valid area identifier configured for identifying a valid area where a scrolling event occurs, as the content area, when the event corresponds to the scrolling event.

38. The system of claim 35, wherein the advertising provider comprises:
a type selector selecting any one of a skyscraper type advertising and a fixed type advertising depending upon a scrolling event; and
a selected typed advertising provider providing the advertising in the selected type.
